(19) United States
(12) Patent Application Publication
(10) Pub. No.: US 2016/0330241 A1
(43) Pub. Date: Nov. 10, 2016

(54) REMOTE PASSWORD MANAGEMENT USING LOCAL SECURITY POLICIES

(71) Applicant: Rene J. Olivera, Hampton, GA (US)

(72) Inventor: Rene J. Olivera, Hampton, GA (US)

(21) Appl. No.: 14/703,377

(22) Filed: May 4, 2015

(51) Int. Cl. H04L 29/06

(52) U.S. Cl. CPC H04L 63/20

(57) ABSTRACT

Disclosed are various examples for remotely managing passwords using local security policies. A computing device enrolls a client device. The computing device then identifies a setting of a local security policy for the client device. Next, the computing device determines whether the setting of the local security policy differs from a corresponding setting specified in a profile. Subsequently, the computing device can update the setting of the local security policy to match the corresponding setting specified in the profile.

### BACKGROUND

A computing device can have a number of settings that control access to the computing device and limit the ability of a user to execute particular applications or access certain files or folders. These settings can be locally modifiable by a user of the computing device. For example, a user can able to change his or her password on the computer or change the permissions of other users to access his or her personal files. A user can also change what applications are installed and change the settings for installed applications.

Some computing devices may expose or otherwise provide a mobile device management (MDM) application programming interface (API). The MDM API may, for example, expose specific functions that allow a remote application or remote computing device to manage various settings of the computing device. For example, the remote application can use various functions exposed by the MDM API to change password requirements for a user, install or uninstall applications on the computing device, change a user's permissions to access various files or execute various programs, change the settings for an installed application, and other settings.

However, not all computing devices offer an MDM API to facilitate management of the settings of the computing device. For example, the operating system on some computing devices may not include an MDM API. Without an MDM API, a remote application or remote computing device could be unable to manage and/or modify the settings of the computing device. In addition, the MDM API may not offer the same granular level of control of settings as other solutions, such as those provided when a computing device is connected to a directory service, such as when a computing device is connected to a domain controller for Microsoft's Active Directory®.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a drawing depicting the operation of various examples of the disclosure in a networked environment.

FIG. 1B is a drawing depicting the operation of various examples of the disclosure in a networked environment.

FIG. 2 is a flowchart illustrating one example of functionality according to various examples of the disclosure.

FIG. 3 is a flowchart illustrating one example of functionality implemented in a client device according to various examples of the disclosure.

### DETAILED DESCRIPTION

Disclosed are various examples for remotely managing and enforcing password policies on client devices using local security policies of the client devices. A client device can have a local security policy that specifies password requirements, access requirements, and whether particular security features are enabled or disabled. A client application executing on the client device can determine the values for individual settings of the local security policy and can send the values of the individual settings to a management system executing on a remote device, such as a server. The management system can determine whether the values specified for the settings of the local security policy match the values for corresponding settings stored in a profile for the client device. If the values of the settings of the local security policy differ from the values of the corresponding settings in the profile, then the management system can respond to the client application with the values stored in the profile of the settings that differ. The client application can then update the local security policy to match the values received from the management system, thereby allowing for the security policy of the client device to be managed by the remote device.

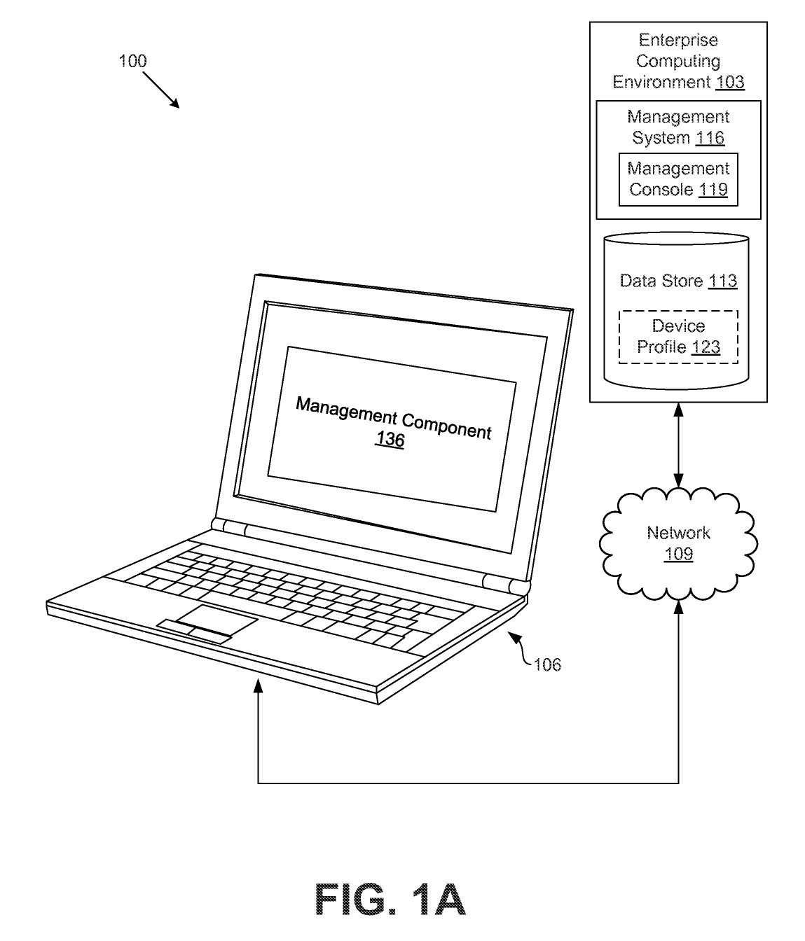

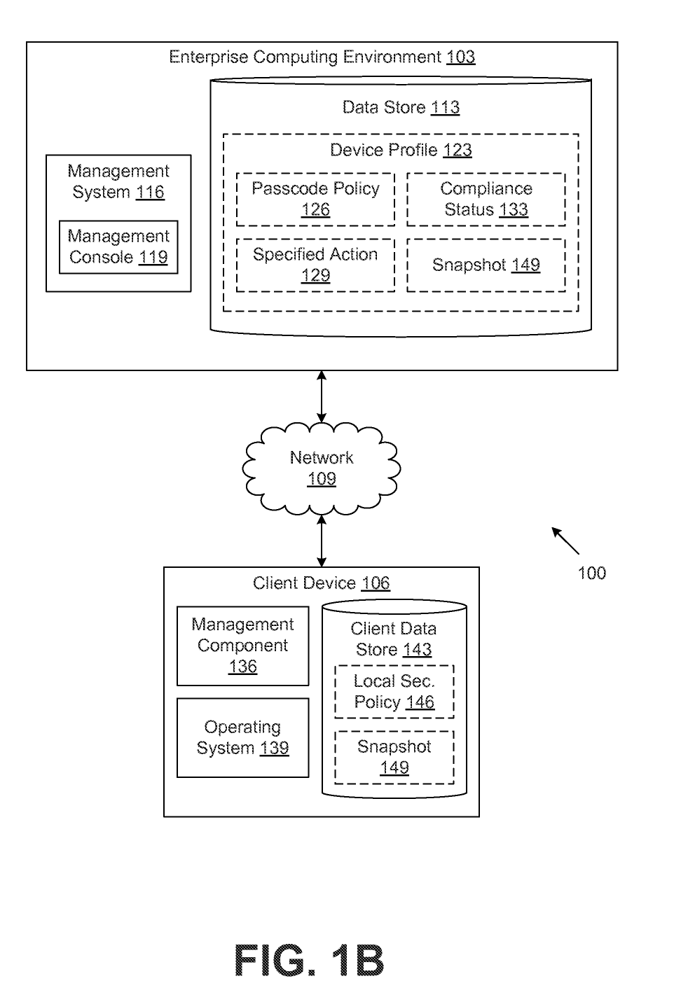

With reference to FIG. 1A, shown is an illustrative example of a networked environment 100 according to examples of the disclosure. In the depicted network environment 100, an enterprise computing environment 103 is in data communication with at least one client device 106 over a network 109. As will be further described herein, various security settings of the client device 106 can be controlled by a local security profile, such as whether a password is required to logon to the client device 106, a required length of the password, permissible characters for use in the password, whether a password is required to unlock a screensaver of the device, and similar settings. Although the local security policy can be stored on the client device 106, individual settings can be stored in the data store 113, as will be further described below. These settings can be sent to the client device 106 by the management system 116 and they can be set via a user interface provided by the management console 119.

The networked environment 100 includes an enterprise computing environment 103 and a client device 106 which are in data communication with each other over a network 109. The network 109 includes the Internet, intranets, extranets, wide area networks (WANs), local area networks (LANs), wired networks, wireless networks, other suitable networks, or any combination of two or more such networks. The networks can include satellite networks, cable networks, Ethernet networks, and other types of networks.

The enterprise computing environment 103 can be a computing environment that is operated by an enterprise, such as a business or other organization. The enterprise computing environment 103 includes a computing device, such as a server computer, that provides computing capabilities. Alternatively, the enterprise computing environment 103 can employ multiple computing devices that are arranged in one or more server banks or computer banks. In one example, the computing devices can be located in a single installation. In another example, the computing devices for the enterprise computing environment 103 can be distributed among multiple different geographical locations. In one case, the enterprise computing environment 103 includes multiple computing devices that together can form a hosted computing resource or a grid computing resource. Additionally, the enterprise computing environment 103 can operate as an elastic computing resource where the allotted capacity of computing-related resources, such as processing resources, network resources, and storage resources, can vary over time. In other examples, the enterprise computing environment 103 can include or be operated as one or more virtualized computer instances that can be executed to perform the functionality that is described herein. Generally, the enterprise computing environment 103 can be operated in accordance with particular security protocols such that the enterprise computing environment 103 can be considered a “trusted” computing environment by the enterprise that operates the enterprise computing environment 103.

Various applications and/or other functionality can be executed in the enterprise computing environment 103 according to various examples. Also, various data can be stored in a data store 113 that can be accessible to the enterprise computing environment 103. The data store 113 can be representative of a plurality of data stores 113. The data stored in the data store 113 can be associated with the operation of the various applications and/or functional entities described below.

The client device 106 can represent multiple client devices 106 coupled to the network 109. The client device 106 includes, for example, a processor-based computer system. According to various examples, a client device 106 can be in the form of a desktop computer, a laptop computer, a personal digital assistant, a mobile phone, a web pad, or a tablet computer system. The client device 106 includes output devices, such as a display and audio speakers, as well as one or more input devices, such as a mouse, keyboard, touch pad, or touch screen, which can facilitate a user interacting with the client device 106. The client device 106 can also execute a management component 136, for example, to monitor and manage data, software components, and hardware components with respect to the client device 106, as described in further detail below.

With reference to FIG. 1B, shown is schematic diagram of the networked environment 100 according to various examples of the present disclosure. An enterprise computing environment 103 can be in data communication with a client device 106 over a network 109. The components executed on the enterprise computing environment 103 can include a management system 116 and other applications, services, processes, systems, engines, or functionality not discussed in detail herein. The management system 116 can be executed in the enterprise computing environment 103 to monitor and manage the operation of one or more client devices 106. In some examples, the management system 116 can include a management console 119, which can facilitate the administration of client devices 106 by administrators. For instance, the management console 119 can generate user interfaces that can be rendered on a display device to facilitate administrators operating and interacting with the management system 116. Such user interfaces can facilitate an administrator inputting commands or other information for the management system 116. The user interfaces can also include, for example, presentations of statistics or other information regarding the client devices 106 that can be managed by the management system 116.

The data stored in the data store 113 can include one or more device profiles 123 and potentially other data. A device profile 123 can represent various security settings selected for enforcement on a client device 106 connected to the enterprise computing environment 103. Accordingly, a device profile 123 can include a passcode policy 126, a specified action 129, a compliance status 133, one or more snapshots 149, and potentially other data.

A passcode policy 126 can represent one or more polices or requirements for passwords or passcodes of users of the client device 106. A passcode policy 126 can require the use of a password by any user of the client device 106 and/or for any user to login to the client device 106. A passcode policy 126 can also specify that a password comply with various requirements, such as a minimum or maximum number of characters, use a particular type or particular types of characters, or that the password be changed on a periodic basis at predefined or previously specified intervals. As a non-limiting example, a passcode policy 126 can specify that a user of the client device have a password between six and thirty-two characters long that uses at least one upper case letter, one lower case letter, and one number, but no special characters or punctuation marks.

A specified action 129 can represent one or more actions to be performed by the management component 136 on the client device 106 when the value of one or more settings specified in the local security policy 146 do not match the value of the corresponding setting or settings specified in the passcode policy 126. As such, a specified action 129 can be an action to be taken in addition to any action that might be taken by the operation system 139. For example, if the passcode policy 126 and the local security policy 146 specify that a user of the client device 106 must have a password, a specified action 129 can be that the operating system 139 continually prompts the user to create a password. As another example, a specified action 129 can indicate that if the user has not yet created a password, then the management component 136 can restrict access to at least some of the functionality of the client device 106. For example, the specified action 129 can indicate that the management component 136 is to prevent access to particular networks, such as specific wireless networks or virtual private networks. As another example, the specified action 129 can indicate that the management component 136 is to prevent access to particular network resources, such as electronic mail (“e-mail”) servers, network storage or file servers, and/or similar network resources, until a user of the client device 106 has created a password. Other specified actions 129 can be created, for example by using the management console 119, to meet the needs of different use cases according to various examples of the present disclosure.

In some instances, specified actions 129 must be taken in specified order. For example, the settings in a passcode policy 126 may need to be applied and/or enforced before account lockout settings and/or screen lockout settings, such as those described in the examples provided above, are applied and/or enforced. Otherwise, a user could be placed in the position of being locked out of and unable to use the client device 106. For example, the screensaver could activate and required a password or passcode to unlock, but a password or passcode has not yet been set.

A compliance status 133 can represent whether the client device 106 currently complies with the passcode policy 126 specified by the device profile 123. The compliance status 133 can, in some examples, be rendered by the management console 119 to provide a user of the management console 119 with information regarding which client devices 106 are currently compliant with their corresponding passcode policy 126.

A snapshot 149 can represent a state of the local security policy 146 at a specific point in time. One or more snapshots 149 can be stored for a device profile 123. Snapshots 149 are discussed in further detail below during the discussion of the client device 106.

The client device 106 is representative of multiple client devices 106 that are coupled to the network 109. The client device 106 can also be configured to execute a management component 136, an operating system 139, as well as other applications. The client device 106 can also include a local data store 143, which can store one or more local security policies 146, one or more snapshots 149, as well as other data.

The management component 136 can be executed in the client device 106, for example, to monitor and manage data, software components, and hardware components with respect to the client device 106. The management component 136 communicates with the management system 116 to facilitate the management system 116 monitoring and managing the client device 106. For example, the management component 136 transmits data that indicates the status of properties and settings for the client device 106, such as configuration settings for one or more local security policies 146 and other data. The management component 136 can update the local security policy 146. In one example, the management component 136 functions as a device management agent that operates in the application layer of the client device 106. The management component 136, in other examples, can include an application wrapper that interfaces with a software component to facilitate overseeing, monitoring, and managing resources for the client device 106. In alternative examples, the management component 136 includes a portion of an application that was developed, for example, using a Software Development Kit (SDK) so that the monitoring and management functionality is provided using the application.

A local security policy 146 can represent one or more security settings enforced by the operating system 139 and corresponding values for the security settings. These security settings within the local security policy can include whether a password is required for a user to use the client device 106, whether a password is required to login to or unlock the client device 106, a password strength requirement, an account lockout setting, a screensaver lockout setting, and/or other security settings. A password strength requirement can specify a minimum number of characters for a password, the types of permissible characters, a minimum number of characters from a particular set of characters (e.g. a minimum number of letters, a minimum number of numerals, and/or similar requirements). An account lockout setting can specify a maximum number of login attempts for the client device 106 before a user of the client device 106 is locked out or a length of time that a user can be locked out of the client device 106 after failing successfully login to the client device 106. A screensaver lockout setting can specify whether a password is required to exit a screensaver. However, in some examples, the account lockout setting and/or the screen lockout setting may be specified in a separate set of screen inactivity settings.

A snapshot 149 can represent a state of the local security policy 146 at a specific point in time. In some examples, multiple snapshots 149 can be stored in the client data store 143. In some examples, a copy of the snapshot 149 can also be stored in the device profile 123 of the client device 106 located in the data store 113. A snapshot 149 can be used, for example, to undo, rollback, or otherwise reverse changes to the local security policy 146, such as changes to the local security policy 146 made by a user of the client device 106 that would conflict with the settings specified by the device profile 123.

Next, a general description of the operation of the various components of the networked environment 100 is provided. To begin, a client device 106 can be enrolled with the management system 116 in response to installation of the management component 136 on the client device 106. As part of the enrollment process, a device profile 123 can be created and associated with the client device 106. An initial passcode policy 126 and an initial set of specified actions 129, which can have been previously specified using the management console 119, can be included in the device profile 123.

The management system 116 can then analyze an initial copy of the local security policy 146 provided by the management component 136 during installation to determine if the local security policy 146 complies with the passcode policy 126. If the local security policy 146 is compliant with the passcode policy 126, then the compliance status 133 can be set to indicate that the client device 106 is currently compliant and the management system 116 can wait for subsequent messages from the client device 106. In some examples, an initial snapshot 149 can also be created at this time as part of the device profile 123 based at least in part on a copy of the local security policy 146 currently in place at the time that the management component 136 was installed.

However, if the local security policy 146 is not compliant with the passcode policy 126, then the compliance status 133 can be set to indicate that the client device 106 is not currently compliant with the passcode policy 126. The management system 116 then sends a message to the management component 136 indicating the changes that need to be made to the local security policy 146 to bring the local security policy 146 into compliance with the passcode policy 126. In some examples, the management system 116 can also send one or more specified actions 129 to the management component 136. The management system 116 can then wait for a subsequent message from the client device 106.

After enrollment, the management component 136 can make any changes to the local security policy 146 that are necessary to bring the local security policy 146 into compliance with the passcode policy 126 specified in the device profile 123 for the client device 106. If necessary, the management component 136 can also execute or undertake one or more specified actions 129 received from the management system 116.

The management component 136 can periodically send a copy of the local security policy 146 to the management system 116 for compliance analysis. For example, the management component 136 can send the copy of the local security policy 146 every minute, every 15 minutes, every hour, or at other intervals. The management system 116 can compare the received local security policy 146 to the current passcode policy 126 to determine whether the local security policy 146 of the client device 106 is currently in compliance with the passcode policy 126. The compliance status 133 can be updated as appropriate and differences between the current copy of the local security policy 146 and the passcode policy 126 can be resolved in a manner similar to that previously described and/or as will be further described herein. Because the management component 136 can periodically send a copy of the local security policy 146 to the management system 116, unauthorized changes to the local security policy 146, such as manual edits made by a user of the client device 106, can be detected and resolved. In addition, updates to the passcode policy 126 can be propagated to the local security policy 146 of the client device 106 in this manner. However, in some examples, updates to the passcode policy 126 can be sent by the management system 116 to the management component 136 as soon as, or shortly after, the passcode policy 126 has been modified to avoid waiting for the management component 136 to send a copy of the local security policy 146 for analysis.

The management component 136 can also periodically take one or more snapshots 149 of the local security policy 146. The management component 136 can take a snapshot 149 at predefined intervals of time (e.g. every minute, 15 minutes, hourly, or at other intervals) and/or upon the occurrence of an event, such as after the management component 136 has modified the local security policy 146. The management component 136 can then periodically compare the local security policy 146 to the snapshot 149, such as the latest one of the snapshots 149, to determine whether an unauthorized change to the local security policy 146 has occurred. For example, a user of the client device 106 could have manually changed a configuration of the local security policy 146 to bypass one or more security restrictions or settings. If the local security policy 146 differs from the snapshot 149, the management component 136 can change the local security policy 146 to match the state of the local security policy 146 as represented in the snapshot 149, thereby undoing the unauthorized change. In some examples, the snapshot 149 can be uploaded to, and retrieved from, the device profile 123 instead of the snapshot 149 being stored in the client data store 143 to minimize the opportunity for a user of the client device 106 to edit the snapshot 149.

In some instances, the management component 136 can incorporate additional functionality. For example, the management component 136 can display a password “hint” to users who have forgotten their password. The password hint can be created by a user when they create their password and modified when a user changes his or her password.

As another example of additional functionality, the management component 136 can reset a user's password. For example, an administrator can use the management console 119 to instruct the management system 116 to send a password reset command to the management component. The password reset command could include a new password for the user, or simply instruct the management component 136 to erase the user's current password. If only the user's password is erased, the management component 136 can prompt the user to create a new password on his or her next login. This allows a user's password for the client device 106 to be wiped or reset remotely without the client device 106 having to be joined to a directory service, such as Microsoft Active Directory®, for access to this functionality.

As another example of additional functionality, the management component 136 can wipe the client device 106. As part of the wiping process, previously specified application settings, user settings, and data may be deleted by the management component 136 upon receipt of a wipe command from the management system 116. For example, if an employer issues a wipe command to a client device 106, company emails may be deleted from the client device 106 and the email account settings may be deleted. Various settings for the local security policy 146 can also be changed. For example, password settings in the local security policy 146 may be reset to default values.

In some examples, the ability for the management component 136 to implement one or more of the various functions described in this application may be limited by a setting in the device profile 123. For example, if the device profile 123 indicates that the client device 106 is privately owned by the user, some functionality may be disabled, such as the ability of the management component 136 to wipe the client device 106, can be disabled. Settings in the device profile 123 indicating ownership can be set during the enrollment process when the management component 136 is installed on the client device 106.

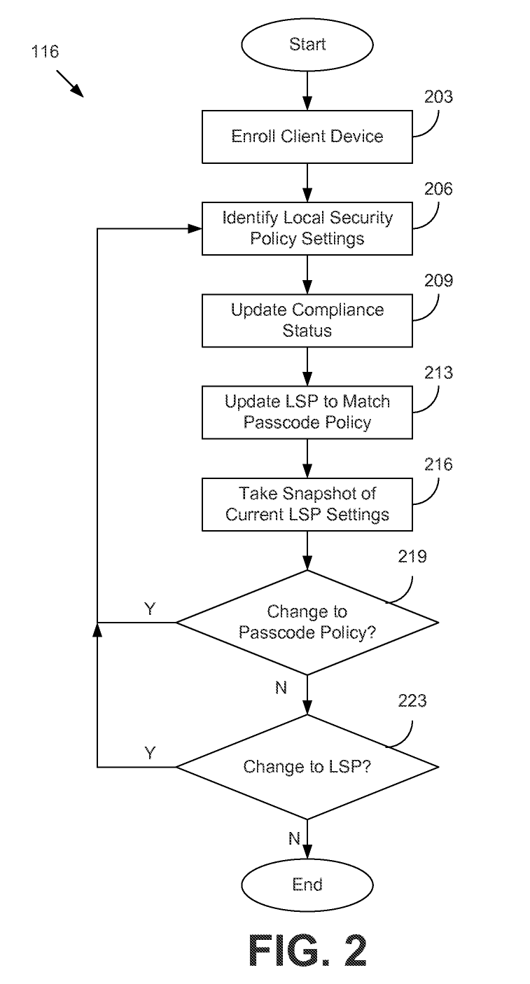

Referring next to FIG. 2, shown is a flowchart that provides one example of the operation of a portion of the management system 116 according to various examples. It is understood that the flowchart of FIG. 2 provides merely an example of the many different types of functional arrangements that can be employed to implement the operation of the portion of the management system 116 as described herein. As an alternative, the flowchart of FIG. 2 can be viewed as depicting an example of elements of a method implemented in the enterprise computing environment 103 (FIG. 1) according to one or more examples.

Initially, a management component 136 (FIG. 1B) can be installed on a client device 106 (FIG. 1B) that can be managed by the management system 116. For example, the management component 136 may be installed by a user or administrator of the client device 106. Then, beginning at step 203, the client device 106 can be enrolled for management by the management system 116. As part of the enrollment process, the management system 116 can create a device profile 123 (FIG. 1B) in the data store 113 (FIG. 1B) corresponding to the client device 106 being enrolled. The management system 116 can then add to the device profile 123 an initial passcode policy 126 (FIG. 1B) and an initial specified action 129 (FIG. 1B). The initial passcode policy 126 and initial specified action 129 can be a default passcode policy 126 and specified action 129 or can been previously indicated or selected via the management console 119.

Moving on to step 206, the management system 116 can identify settings for the current local security policy 146 and their current values. In instances where the operating system 139 (FIG. 1B) of the client device 106 fails to provide a mobile device management (MDM) application programming interface (API), the management system may receive a copy of the current local security policy 146, including any settings and values, as part of a message from the management component 136. The settings for the current local security policy 146 and their current values can be parsed from the message. However, in some examples, the management system 116 can query the management component 136 for the current settings and corresponding values of the local security policy 146. For example, the management system 116 could query the management component 136 if the management system 116 has not yet received a copy of the local security policy 146. For example, the management system 116 may poll the management component 136 for the current state of the local security policy 146 and received a copy of the local security policy 146 from the management component 136 in response.

Referring next to step 209, the management system 116 can update the compliance status 133 (FIG. 1B) of the device record 123 of the client device 106. For example, the management system 116 can compare each setting and value specified in the passcode policy 126 of the device record 123 of the client device 106 to the corresponding setting and value specified in the local security policy 146 stored on the client device 106. If the values for the settings match, then the management system 116 can update the compliance status 133 to indicate that the local security policy 146 of the client device is compliant with the passcode policy 126 for the client device 106. However, if the values for the settings do not match, then the management system 116 can update the compliance status 133 to indicate that the local security policy 146 of the client device is not compliant with the passcode policy 126 for the client device 106.

The local security policy 146 can fail to comply with the passcode policy 126 for any one or more of a number of reasons. For example, when the management component 136 is initially installed, the local security policy 146 can fail to comply with the passcode policy 126 because the management system 116 has not yet had a chance to synchronize the local security policy 146 with the passcode policy 126. After the management component 136 is installed, updates to the passcode policy 126 can cause a previously compliant local security policy 146 to no longer be compliant with the passcode policy 126. Similarly, if a user changes one or more of the settings in the local security policy 146, this can cause a previously compliant local security policy 146 to no longer be compliant with the passcode policy 126.

Proceeding next to step 213, the management system 116 can update the local security policy 146 to match the passcode policy 126. For example, the management system 116 can send a message to the management component 136 identifying individual settings of the local security policy 146 that need to be updated and the new value for each setting. The management component 136 would then modify the local security policy 146 on the client device 106 to match the settings identified and values specified in the message, as further described below. In other examples, the management system 116 can create a new copy of the local security policy 146 with updated values for the settings that need to be updated and send the copy of the local security policy 146 to the management component 136 for the management component 136 to use to replace the current version of the local security policy 146. The management component 136 could then replace the local security policy 146 on the client device 106 with the copy of the local security policy 146 received from the management system 116, as further described below.

Moving on to step 216, the management system 116 can take a snapshot 149 of the updated local security policy 146. The management system 116 may, for example, store a copy of the updated local security policy 146 in the device profile 123 in the data store 113. In various examples, the management system 116 may, for example, send the snapshot 149 to the management component 136 for storage in the client data store 143.

Referring next to step 219, the management system 116 can determine whether the passcode policy 126 has changed. The passcode policy 126 can be changed, for example, with the management console 119. If the passcode policy 126 has changed, then the previously described process loops back to step 206, so that the local security policy 146 can be updated to comply with the changed passcode policy 126. If the passcode policy 126 has not changed, then the previously described process continues to step 223.

Proceeding next to step 223, the management system 116 can determine whether the local security policy 146 has been changed. For example, the management component 136 can periodically report the current state of the local security policy 146 to the management system 116. The management system 116 can compare the provided state of the local security policy 146 with a snapshot 149 of the local security policy 146, such as the snapshot 149 taken previously at step 216 or some other snapshot 149. If the provided state of the local security policy 146 differs from the snapshot 149 to which it is compared, then the management system 116 can determine that the local security policy 146 has been changed since the snapshot 149 was taken. If the local security policy 146 has changed, then the previously described process loops back to step 206, so that the local security policy 146 can be updated to comply with the changed passcode policy 126. If the local security policy 146 has not changed, then the previously described process subsequently ends.

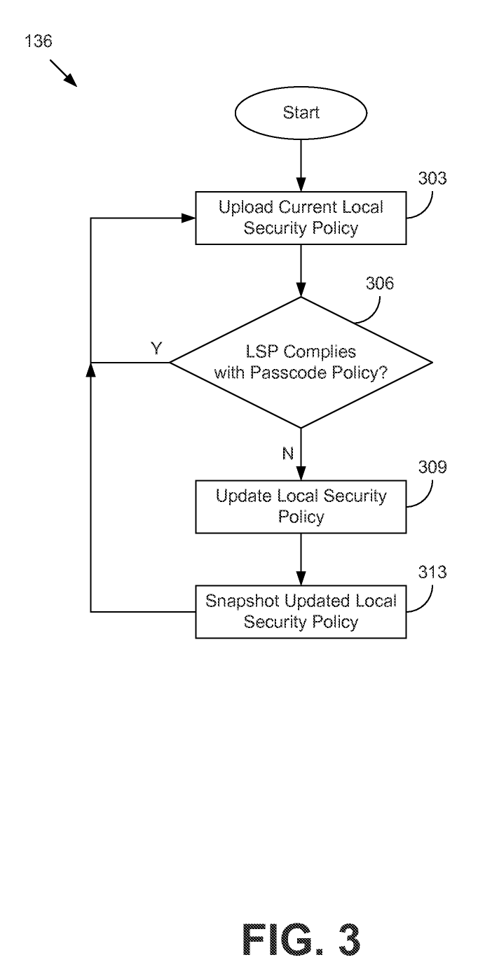

Referring next to FIG. 3, shown is a flowchart that provides one example of the operation of a portion of the management component 136 of FIG. 1B, according to various examples. It is understood that the flowchart of FIG. 3 provides merely one example of the many different types of functional arrangements that can be employed to implement the operation of the portion of the management component 136 as described herein. As an alternative, the flowchart of FIG. 3 can be viewed as depicting an example of elements of a method implemented in the client device 106 (FIG. 1B) according to one or more examples.

Initially, the management component 136 is installed on the client device 106 (FIG. 1B). Proceeding then to step 303, the management component 136 can upload a copy of the current local security policy 146 (FIG. 1B) to the management system 116 (FIG. 1B). The upload can occur in response to, or as part of, the installation process. However, the upload can also occur in response to other conditions or triggers. For example, the management component 136 may upload a copy of the current state or version of the local security policy 146 on a periodic basis (e.g. every minute, every 15 minutes, every hour, every day, or at other intervals). The management component 136 can also upload a copy of the current state or version of the local security policy 146 in response to one or more triggers or conditions described below.

In order to upload the current state or a copy of the local security policy 146, the management component 136 may access the local security policy 146 through one or more mechanisms provided by the operating system 139 of the client device 106. For example, the management component 136 may read the values of one or more settings stored in the Windows® registry, a configuration file for the operating system 139, or other location. The values and identifiers of the settings corresponding to each value are then assembled into a message that is sent to the management system 116.

Moving on to step 306, the management component 136 can determine whether the current local security policy 146 complies with the passcode policy 126 (FIG. 1B) established for the client device 106. The management component 136 can, for example, analyze a response received from the management system 116. If the management system 116 sends a response that does not contain or otherwise indicate any changes to the values of the settings for the local security policy 146, then the management component 136 can determine that the local security policy 146 complies with the passcode policy 126. In this case, the management component 136 can wait for a predefined amount of time before looping back to step 303. However, if the management system 116 sends a response with a list of changes to the values of settings in the local security policy 146, then the management component 136 can determine that the local security policy 146 needs to be changed. In this case, the previously described process of the management component 136 proceeds to step 309.

Referring next to step 309, the management component 136 updates the local security policy 146. The management component 136 may, for example, enable or disable settings controlled by the local security policy 146 to match the passcode policy 126. In various examples, the management component 136 can also change the value of individual settings of the local security policy 146 to match the value of the corresponding settings of the passcode policy 126. For example, the management component 136 may change the values of various settings in the Windows® registry, update or modify the values of settings specified in a configuration file, or perform other actions.

Proceeding next to step 313, the management component 136 takes a snapshot 149 (FIG. 1B) of the local security policy 146. The management component 136 may, for example, make a copy of the local security policy 146 to save as the snapshot 149. In various examples, the management component 136 can save the changes between the last snapshot 149 and the current local security policy 146 or follow a similar differential backup approach. The management component 136 can save the snapshot 149 to the client data store 143 or, in some examples, can upload the snapshot 149 to the management system 116 for storage in the device profile 123 of the client device 106. The previously described process then loops back to step 303 to continue keeping the local security policy 146 in compliance with the passcode policy 126, although in some examples, the previously described process can subsequently end.

The flowcharts of FIGS. 2 and 3 show examples of the functionality and operation of implementations of components described herein. The components described herein can be embodied in hardware, software, or a combination of hardware and software. If embodied in software, each element can represent a module of code or a portion of code that includes program instructions to implement the specified logical function(s). The program instructions can be embodied in the form of source code that includes human-readable statements written in a programming language and/or machine code that includes machine instructions recognizable by a suitable execution system, such as a processor in a computer system or other system. If embodied in hardware, each element can represent a circuit or a number of interconnected circuits that implement the specified logical function(s).

Although the flowcharts of FIGS. 2 and 3 show a specific order of execution, it is understood that the order of execution can differ from that which is shown. The order of execution of two or more elements can be switched relative to the order shown. Also, two or more elements shown in succession can be executed concurrently or with partial concurrence. Further, in some examples, one or more of the elements shown in the flowcharts can be skipped or omitted. In addition, any number of counters, state variables, warning semaphores, or messages might be added to the logical flow described herein, for purposes of enhanced utility, accounting, performance measurement, and/or troubleshooting aid. It is understood that all such variations are within the scope of the present disclosure.

The enterprise computing environment 103, the client device 106, and/or other components described herein can each include at least one processing circuit. Such a processing circuit can include one or more processors and one or more storage devices that are coupled to a local interface. The local interface can include a data bus with an accompanying address/control bus or any other suitable bus structure.

The one or more storage devices for a processing circuit can store data and/or components that are executable by the one or processors of the processing circuit. The management system 116, management component 136, and/or other components can be stored in one or more storage devices and be executable by one or more processors. Also, a data store, such as the data store 113 or the client data store 143, can be stored in the one or more storage devices.

The management system 116, the management component 136, and other components described herein can be embodied in the form of hardware, as software components that are executable by hardware, or as a combination of software and hardware. If embodied as hardware, the components described herein can be implemented as a circuit or state machine that employs any suitable hardware technology. Such hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that includes software or program instructions can be embodied in any non-transitory computer-readable medium for use by or in connection with an instruction execution system such as a processor in a computer system or other system. Such a computer-readable medium can contain, store, and/or maintain the software or program instructions for use by or in connection with the instruction execution system.

The computer-readable medium can include physical media, such as, magnetic, optical, semiconductor, and/or other suitable media. Examples of a suitable computer-readable media include, but are not limited to, solid-state drives, magnetic drives, flash memory. Further, any logic or component described herein can be implemented and structured in a variety of ways. One or more components described can be implemented as modules or components of a single application. Further, one or more components described herein can be executed in one computing device or by using multiple computing devices.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All such modifications and variations are intended to be included herein within the scope of this disclosure.

Therefore, the following is claimed:

1. A non-transitory computer-readable medium embodying a program executable in a computing device, wherein the program is configured to cause the computing device to at least:
enroll a client device with a management system;
identify a value for a setting of a local security policy for the client device, wherein the local security policy is received from a client management application installed on the client device;
determine that the value for the setting of the local security policy differs from a corresponding value for a corresponding setting specified in a profile for the client device; and
send an updated value for the setting of the local security policy to the client management application and an instruction to the client management application to change the local security policy to reflect the updated value, wherein the updated value for the setting matches the corresponding value for the corresponding setting.

2. The non-transitory computer-readable medium of claim 1, wherein the program is further configured to cause the computing device to at least update a compliance status of the client device based at least in part on a determination that the value for the setting of the local security policy differs from the corresponding value for the corresponding setting.

3. The non-transitory computer-readable medium of claim 1, wherein the setting of the local security policy comprises at least one of a password strength requirement, an account lockout setting, or a screensaver lockout setting.

4. The non-transitory computer-readable medium of claim 1, wherein the program is further configured to cause the computing device to send an action specified in the profile to the client management application, wherein the action specified in the profile defines a response to be taken by the client management application upon a determination by the client management application that a current state of the client device fails to comply with the updated setting of the local security policy.

5. The non-transitory computer-readable medium of claim 1, wherein the program is further configured to cause the computing device to send an action specified in the profile to the client management application, wherein the action specified in the profile defines a response to be taken by the client management application upon a determination by the client management application that the local security policy has changed.

6. The non-transitory computer-readable medium of claim 1, wherein the program is further configured to cause the computing device to:
save a snapshot of the local security policy, wherein the snapshot is provided by the client management application in response to the client management application updating the local security policy;
determine that a later version of the local security policy received from the client management application differs from the snapshot of the local security policy; and
send the snapshot of the local security policy to the client management application for the client management application to restore the local security policy to a state that matches the snapshot.

7. A method comprising:
enrolling, by a computing device, a client device with a management system;
identifying, by the computing device, a value for a setting of a local security policy for the client device, wherein the local security policy is received from a client management application installed on the client device;
determining, by the computing device, that the value for the setting of the local security policy differs from a corresponding value for a corresponding setting specified in a profile for the client device; and
sending, by the computing device, an updated value for the setting of the local security policy to the client management application and an instruction to the client management application to change the local security policy to reflect the updated value, wherein the updated value for the setting matches the corresponding value for the corresponding setting.

8. The method of claim 7, further comprising updating, by the computing device, a compliance status of the client device based at least in part on determining that the value for the setting of the local security policy differs from the corresponding value for the corresponding setting.

9. The method of claim 7, wherein the setting of the local security policy comprises at least one of a password strength requirement, an account lockout setting, or a screensaver lockout setting.

10. The method of claim 7, further comprising sending, by the computing device, an action specified in the profile to the client management application, wherein the action specified in the profile defines a response to be taken by the client management application upon a determination by the client management application that a current state of the client device fails to comply with the updated setting of the local security policy.

11. The method of claim 7, further comprising sending, by the computing device, an action specified in the profile to the client management application, wherein the action specified in the profile defines a response to be taken by the client management application upon a determination by the client management application that the local security policy has changed.

12. The method of claim 7, further comprising:
saving, by the computing device, a snapshot of the local security policy, wherein the snapshot of the local security policy is provided by the client management application in response to the client management application updating the local security policy;
determining, by the computing device, that a later version of the local security policy received from the client management application differs from the snapshot of the local security policy; and
sending, by the computing device, the snapshot of the local security policy to the client management application for the client management application to restore the local security policy to a state that matches the snapshot.

13. A system comprising:
a client computing device; and
an application executable by the client computing device, wherein the application comprises:
logic that accesses a local security policy provided by an operating system of the client computing device;
logic that determines a value for a setting of the local security policy;
logic that sends the value for the setting and an identification of the setting to a management system executing on a server computing device; and
logic that instructs the operating system to modify the value of the setting of the local security policy in response to receiving an updated value from the management system.

14. The system of claim 13, wherein the application further comprises:
logic that queries the operating system for a current state of the client computing device;
logic that determines whether the current state of the client computing device fails to match the updated value of the local security policy; and
logic that performs a specified action in response to a determination that the current state of the client computing device fails to match the updated value of the local security policy, wherein the specified action was previously provided by the management system.

15. The system of claim 14, wherein the application performs the specified action until the current state of the client computing device complies with the updated value of the local security policy.

16. The system of claim 14, wherein the specified action comprises at least one of:
generation of a user interface prompt for a change to a password; or
refusal of a login to the client computing device for a predefined period of time.

17. The system of claim 13, wherein the application further comprises:
logic that detects a change to the value of the setting of the local security policy, wherein the change is made on the client computing device; and
logic that reverts the change to the value of the setting of the local security policy to an earlier version of the value of the setting of the local security policy.

18. The system of claim 13, wherein the application further comprises:
logic that detects a change to the value of the setting of the local security policy, wherein the change is made on the client device; and
logic that sends the change to the value of the setting of the local security policy to the management system.

19. The system of claim 18, wherein the application further comprises logic that performs a specified action in response to detection of the change to the value of the setting of the local security policy, wherein the specified action was previously provided by the management system.

20. The system of claim 13, wherein the setting of the local security policy comprises at least one of a password strength requirement, an account lockout setting, or a screensaver lockout setting.
